(19) United States
(12) Patent Application Publication
(10) Pub. No.: US 2019/0163492 A1
(43) Pub. Date: May 30, 2019

(54) EMPLOYING A STACK ACCELERATOR FOR STACK-TYPE ACCESSES

(71) Applicant: INTERNATIONAL BUSINESS MACHINES CORPORATION, Armonk, NY (US)

(72) Inventors: Michael K. Gschwind, Chappaqua, NY (US); Chung-Lung K. Shum, Wappingers Falls, NY (US); Timothy J. Slegel, Staatsburg, NY (US); Jonathan D. Bradbury, Poughkeepsie, NY (US)

(21) Appl. No.: 15/824,649

(22) Filed: Nov. 28, 2017

(51) Int. Cl. G06F 9/38; G06F 9/30

(52) U.S. Cl. CPC G06F 9/3859; G06F 9/30163; G06F 9/3838; G06F 9/30167; G06F 9/3863

(57) ABSTRACT

A stack accelerator is employed for stack-type accesses. An instruction stream is scanned for stack-type accesses. These stack-type accesses may include push and pop stack operations. Based on identifying a stack-type access in the instruction stream, memory operations are replaced with one or more operations that access a stack in a stack accelerator.

### BACKGROUND

One or more aspects relate, in general, to processing within a computing environment, and in particular, to facilitating such processing.

Many applications executing within a computing environment use stacks for various tasks, including performing computations. For example, an application may read values from a stack, perform a computation (e.g., add, subtract, multiply, divide, etc.), and store a result of the computation back on the stack. Other uses are also possible.

In one example, such a stack is implemented in software by the application, and a pointer to the stack is provided in hardware (e.g., a register). Applications, such as interpreters for computer languages, including Java (JVM byte code), Python, Forth, etc., use such stacks for computations and/or other tasks, since they are easy to implement.

### SUMMARY

Shortcomings of the prior art are overcome and additional advantages are provided through the provision of a computer program product for facilitating processing within a computing environment. The computer program product includes a computer readable storage medium readable by a processing circuit and storing instructions for performing a method. The method includes, for instance, identifying a stack-type access to perform an operation on a stack. The stack is located in a stack accelerator of a processor. Based on determining the stack-type access, one or more memory operations to perform the operation are replaced with one or more operations to perform the operation directly on the stack located in the stack accelerator

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to incorporate and use one or more aspects of the present invention;

FIG. 1B depicts further details regarding a processor of FIG. 1A, in accordance with an aspect of the present invention;

FIG. 1C depicts further details of one example of an instruction execution pipeline used in accordance with one or more aspects of the present invention;

FIG. 1D depicts further details of one example of a processor, in accordance with an aspect of the present invention;

FIG. 2 depicts one embodiment of processing associated with detecting stack-type accesses and replacing those accesses, in accordance with an aspect of the present invention;

FIG. 3 depicts one embodiment of managing memory operations in relation to using a stack within a stack accelerator, in accordance with an aspect of the present invention;

FIGS. 4A-4C depict an example implementation of a stack, in accordance with an aspect of the present invention;

FIGS. 5A-5B depict one embodiment of facilitating processing within a computing environment, in accordance with an aspect of the present invention;

FIG. 6A depicts another example of a computing environment to incorporate and use one or more aspects of the present invention;

FIG. 6B depicts further details of the memory of FIG. 6A;

FIG. 7 depicts one embodiment of a cloud computing environment; and

FIG. 8 depicts one example of abstraction model layers.

### DETAILED DESCRIPTION

In accordance with one or more aspects of the present invention, processing within a computing environment is facilitated by implementing stacks in a stack accelerator, instead of in memory, in order to improve speed of operations, reduce memory accesses, reduce memory interlocks, and/or improve performance. The stack accelerator is, for instance, implemented as a plurality of storage locations within the processor that are accessed based on relative position within a stack, rather than by memory addresses. In one example, the relative position is the top of stack and a particular in-processor location of the stack accelerator is accessed when that particular location is associated with the top of the stack (e.g., add an element to the top of stack; remove an element from the top of stack). Stack-type accesses are determined, and memory operations (e.g., load and/or store operations) used to perform those accesses are replaced with operations (e.g., read and/or write operations) to access the stack accelerator.

Various aspects are described herein. Further, many variations are possible without departing from a spirit of aspects of the present invention. It should be noted that, unless otherwise inconsistent, each aspect or feature described herein and variants thereof may be combinable with any other aspect or feature.

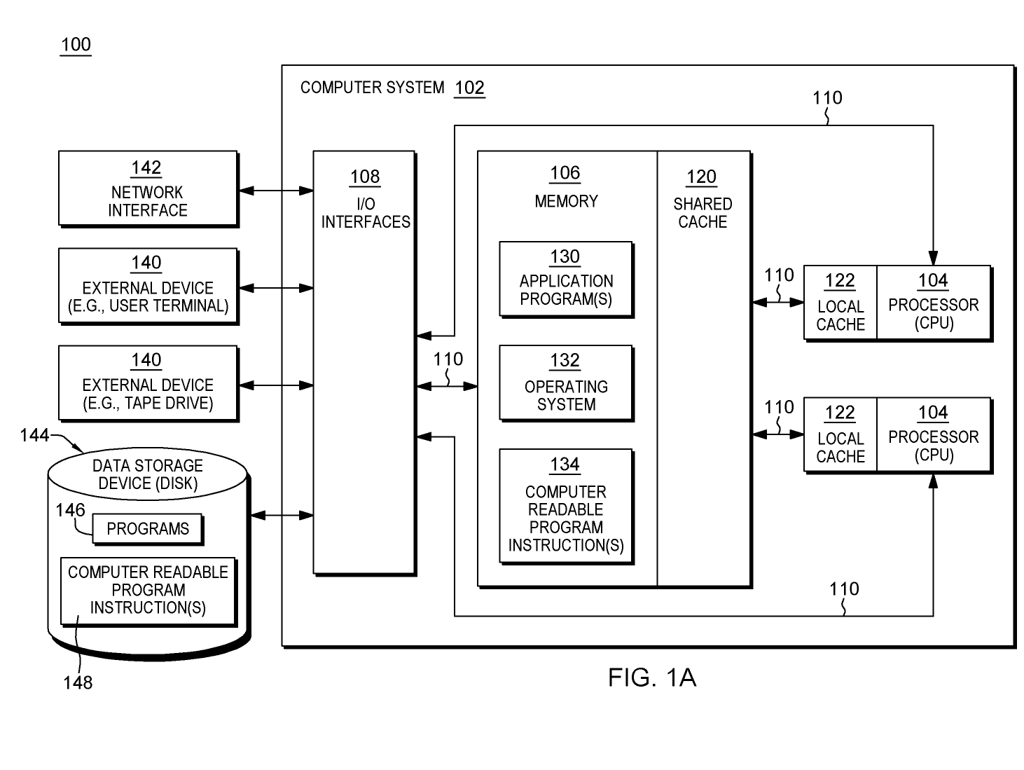

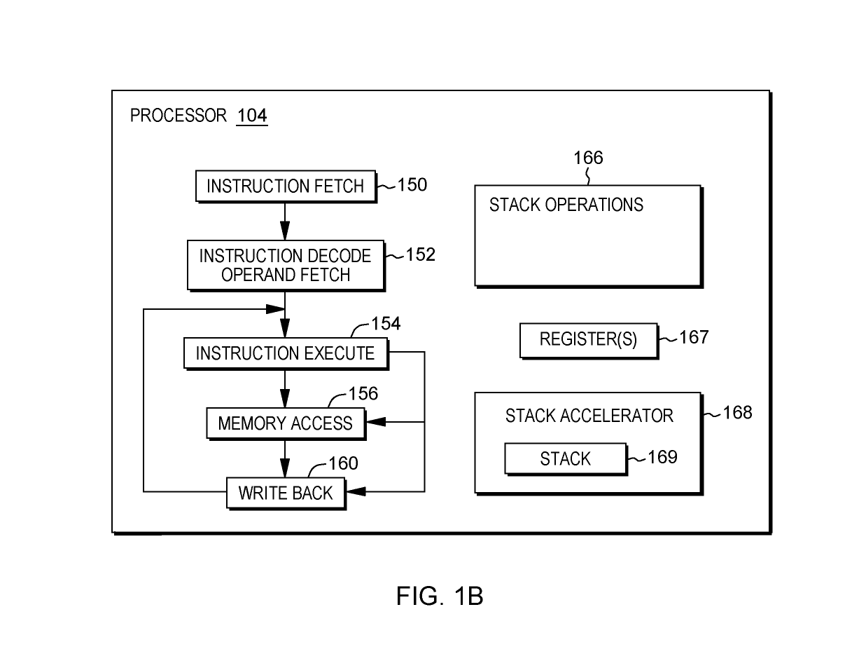

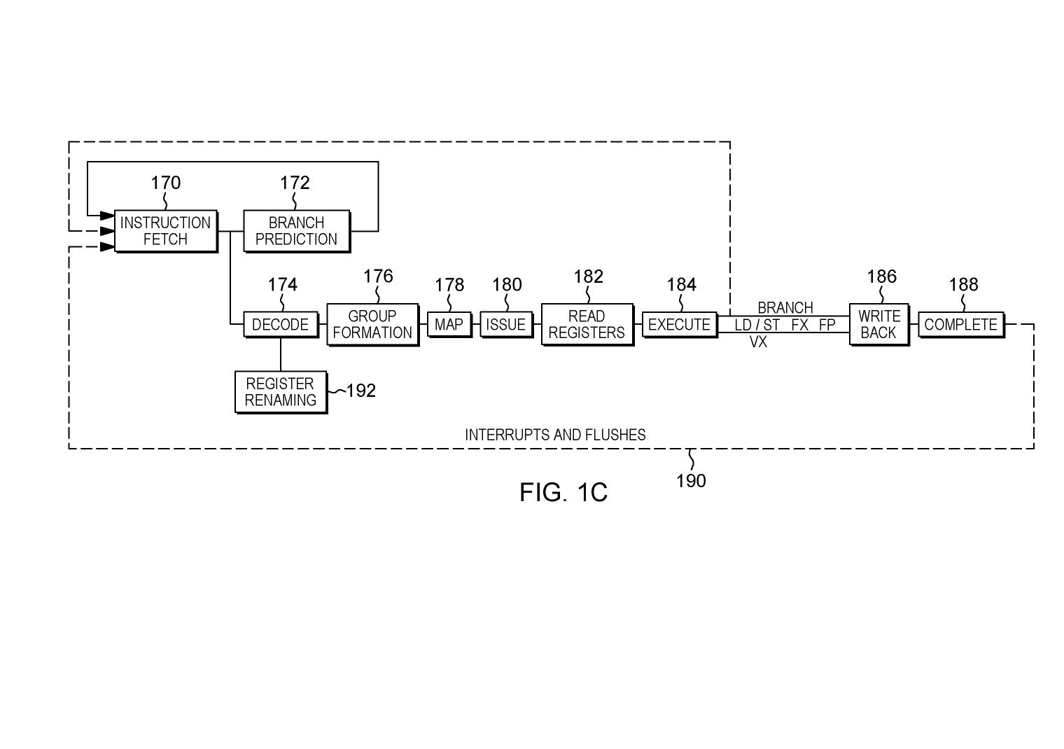

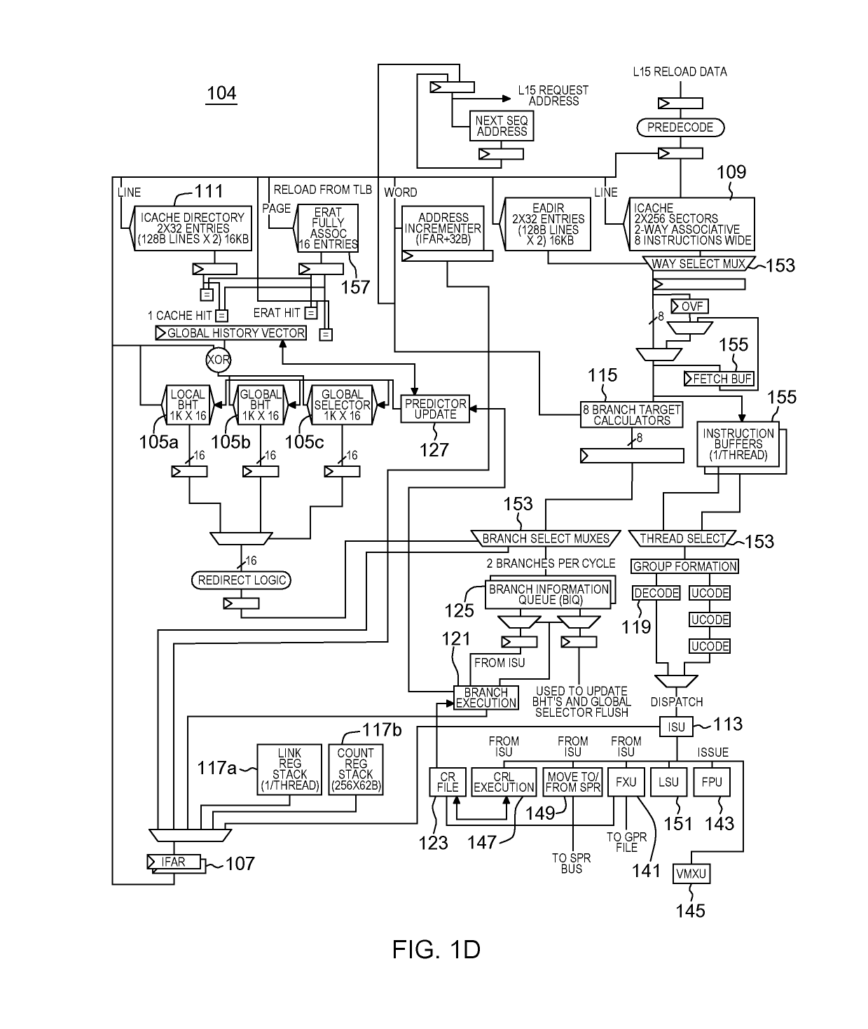

One embodiment of a computing environment to incorporate and use one or more aspects of the present invention is described with reference to FIG. 1A. In one example, the computing environment is based on the z/Architecture, offered by International Business Machines Corporation, Armonk, N.Y. One embodiment of the z/Architecture is described in “z/Architecture Principles of Operation,” IBM Publication No. SA22-7832-10, March 2015, which is hereby incorporated herein by reference in its entirety. Z/ARCHITECTURE is a registered trademark of International Business Machines Corporation, Armonk, N.Y., USA.

In another example, the computing environment is based on the Power Architecture, offered by International Business Machines Corporation, Armonk, N.Y. One embodiment of the Power Architecture is described in “Power ISA™ Version 2.07B,” International Business Machines Corporation, Apr. 9, 2015, which is hereby incorporated herein by reference in its entirety. POWER ARCHITECTURE is a registered trademark of International Business Machines Corporation, Armonk, N.Y., USA.

The computing environment may also be based on other architectures, including, but not limited to, the Intel x86 architectures. Other examples also exist.

As shown in FIG. 1A, a computing environment 100 includes, for instance, a computer system 102 shown, e.g., in the form of a general-purpose computing device. Computer system 102 may include, but is not limited to, one or more processors or processing units 104 (e.g., central processing units (CPUs)), a memory 106 (referred to as main memory, central storage, storage, main storage, memory, as examples), and one or more input/output (I/O) interfaces 108, coupled to one another via one or more buses and/or other connections 110.

Bus 110 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 106 may include, for instance, a cache 120, such as a shared cache, which may be coupled to local caches 122 of processors 104. Further, memory 106 may include one or more programs or applications 130, an operating system 132, and one or more computer readable program instructions 134. Computer readable program instructions 134 may be configured to carry out functions of embodiments of aspects of the invention.

Computer system 102 may also communicate via, e.g., I/O interfaces 108 with one or more external devices 140, one or more network interfaces 142, and/or one or more data storage devices 144. Example external devices include a user terminal, a tape drive, a pointing device, a display, etc. Network interface 142 enables computer system 102 to communicate with one or more networks, such as a local area network (LAN), a general wide area network (WAN), and/or a public network (e.g., the Internet), providing communication with other computing devices or systems.

Data storage device 144 may store one or more programs 146, one or more computer readable program instructions 148, and/or data, etc. The computer readable program instructions may be configured to carry out functions of embodiments of aspects of the invention.

Computer system 102 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 102. Examples, include, but are not limited to: microcode, device drivers, redundant processing units, external disk drive arrays, RAID systems, tape drives, and data archival storage systems, etc.

Computer system 102 may be operational with numerous other general purpose or special purpose computing system environments or configurations. Examples of well-known computing systems, environments, and/or configurations that may be suitable for use with computer system 102 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Further details regarding one example of processor 104 are described with reference to FIG. 1B. Processor 104 includes a plurality of functional components used to execute instructions. These functional components include, for instance, an instruction fetch component 150 to fetch instructions to be executed; an instruction decode unit 152 to decode the fetched instructions and to obtain operands of the decoded instructions; instruction execution components 154 to execute the decoded instructions; a memory access component 156 to access memory for instruction execution, if necessary; and a write back component 160 to provide the results of the executed instructions. One or more of these components may, in accordance with an aspect of the present invention, be used to execute one or more stack operations and/or instructions 166, and/or other operations/instructions associated therewith.

Processor 104 also includes, in one embodiment, one or more registers 167 to be used by one or more of the functional components, and in accordance with an aspect of the present invention, one or more stack accelerators 168. Each stack accelerator 168 may include one or more stacks 169. As an example, a stack accelerator is implemented as a plurality of fast storage locations of the processor. Values may be added or removed from entries of a stack stored in a stack accelerator. Since stacks 169 are located in-processor, they may be referred to herein as in-processor stacks. This is in contrast to in-memory stacks which are accessed by memory operations, such as load and store operations that use memory addresses to access memory locations. The in-processor stacks are accessed by operations that directly access the in-processor stack accelerator, rather than by memory operations. The locations of the stack accelerator are accessed based on relative position within the stack (e.g., top of stack). For instance, an attribute of the stack (e.g., last in first out (LIFO)) is used to access the locations of the stack accelerator. As examples, an element is added to the top of the stack or removed from the top of the stack. The particular storage location of the stack accelerator is accessed when it corresponds to the top of the stack. Other examples are also possible.

Processor 104 may include additional, fewer and/or other components than the examples provided herein.

Further details regarding an execution pipeline of processor 104 are described with reference to FIG. 1C. Although various processing stages of the pipeline are depicted and described herein, it will be understood that additional, fewer and/or other stages may be used without departing from the spirit of aspects of the invention.

Referring to FIG. 1C, in one embodiment, an instruction is fetched 170 from an instruction queue, and branch prediction 172 and/or decoding 174 of the instruction may be performed. The decoded instruction may be added to a group of instructions 176 to be processed together. The grouped instructions are provided to a mapper 178 that determines any dependencies, assigns resources and dispatches the group of instructions/operations to the appropriate issue queues. There are one or more issue queues for the different types of execution units, including, as examples, branch, load/store, floating point, fixed point, vector, etc. During an issue stage 180, an instruction/operation is issued to the appropriate execution unit. Any registers are read 182 to retrieve its sources, and the instruction/operation executes during an execute stage 184. As indicated, the execution may be for a branch, a load (LD) or a store (ST), a fixed point operation (FX), a floating point operation (FP), or a vector operation (VX), as examples. Any results are written to the appropriate register(s) during a write back stage 186. Subsequently, the instruction completes 188. If there is an interruption or flush 190, processing may return to instruction fetch 170.

Further, in one embodiment, coupled to the decode unit is a register renaming unit 192, which may be used in saving/restoring of registers.

Additional details regarding a processor are described with reference to FIG. 1D. In one example, a processor, such as processor 104, is a pipelined processor that may include prediction hardware, registers, caches, decoders, an instruction sequencing unit, and instruction execution units, as examples. The prediction hardware includes, for instance, a local branch history table (BHT) 105a, a global branch history table (BHT) 105b, and a global selector 105c. The prediction hardware is accessed through an instruction fetch address register (IFAR) 107, which has the address for the next instruction fetch.

The same address is also provided to an instruction cache 109, which may fetch a plurality of instructions referred to as a fetch group. Associated with instruction cache 109 is a directory 111.

The cache and prediction hardware are accessed at approximately the same time with the same address. If the prediction hardware has prediction information available for an instruction in the fetch group, that prediction is forwarded to an instruction sequencing unit (ISU) 113, which, in turn, issues instructions to execution units for execution. The prediction may be used to update IFAR 107 in conjunction with branch target calculation 115 and branch target prediction hardware (such as a link register prediction stack 117a and a count register stack 117b). If no prediction information is available, but one or more instruction decoders 119 find a branch instruction in the fetch group, a prediction is created for that fetch group. Predicted branches are stored in the prediction hardware, such as in a branch information queue (BIQ) 125, and forwarded to ISU 113.

A branch execution unit (BRU) 121 operates in response to instructions issued to it by ISU 113. BRU 121 has read access to a condition register (CR) file 123. Branch execution unit 121 further has access to information stored by the branch scan logic in branch information queue 125 to determine the success of a branch prediction, and is operatively coupled to instruction fetch address register(s) (IFAR) 107 corresponding to the one or more threads supported by the microprocessor. In accordance with at least one embodiment, BIQ entries are associated with, and identified by an identifier, e.g., by a branch tag, BTAG. When a branch associated with a BIQ entry is completed, it is so marked. BIQ entries are maintained in a queue, and the oldest queue entry (entries) is (are) de-allocated sequentially when they are marked as containing information associated with a completed branch. BRU 121 is further operatively coupled to cause a predictor update when BRU 121 discovers a branch misprediction.

When the instruction is executed, BRU 121 detects if the prediction is wrong. If so, the prediction is to be updated. For this purpose, the processor also includes predictor update logic 127. Predictor update logic 127 is responsive to an update indication from branch execution unit 121 and configured to update array entries in one or more of the local BHT 105a, global BHT 105b, and global selector 105c. The predictor hardware 105a, 105b, and 105c may have write ports distinct from the read ports used by the instruction fetch and prediction operation, or a single read/write port may be shared. Predictor update logic 127 may further be operatively coupled to link stack 117a and count register stack 117b.

Referring now to condition register file (CRF) 123, CRF 123 is read-accessible by BRU 121 and can be written to by the execution units, including but not limited to, a fixed point unit (FXU) 141, a floating point unit (FPU) 143, and a vector multimedia extension unit (VMXU) 145. A condition register logic execution unit (CRL execution) 147 (also referred to as the CRU), and special purpose register (SPR) handling logic 149 have read and write access to condition register file (CRF) 123. CRU 147 performs logical operations on the condition registers stored in CRF file 123. FXU 141 is able to perform write updates to CRF 123.

Processor 104 further includes a load/store unit 151, and various multiplexors 153 and buffers 155, as well as address translation tables 157, and other circuitry.

Various applications executing within a computing environment implement stacks (referred to herein as software managed stacks) in memory. For instance, interpreters for a variety of computer languages, such as Java (JVM byte code), Python, Forth, etc., implement such stacks. An application reads values from memory and stores those values in a stack. For example, the following operation may be used by an application to store a value from memory onto a stack: stack [tos++]=mem [address], where tos is top of stack, and tos++ adds a value obtained from the memory address to the top of the stack.

Further, an application may read values from a stack, perform a computation and store the results back on the stack. For instance, in one example, an add operation is performed as follows:

stack [−−tos]=operand1;

stack [−−tos]=operand 2;

stack [tos++]=operand1+operand2.

In the above example, −−tos removes a value from the top of the stack. Thus, operand1 and operand2 are popped from the stack, added together, and the result is pushed back on the stack.

Although these types of operations are easy to implement with a software managed in-memory stack, it is an inefficient use of memory and the operations may be slow. Further, there is a risk of interlocks which degrades performance. This is further illustrated below.

One example of pseudocode of a JVM byte code sequence is as follows:

MEMREAD(a1);

MEMREAD(a2);

ADD( );

MEMSTORE(a3)

In the above, two values are read from memory at locations a1 and a2, added together to provide a result, and the result is stored back to memory at location a3. These operations are implemented, in one example, using a stack, as indicated below:

//MEMREAD(a1)

stack [tos++]=mem[a1];

//MEMREAD(a2)

stack [tos++]=mem[a2];

//ADD;

stack [−−tos]=operand1;

stack [−−tos]=operand2;

stack [tos++]=operand1+operand2;

//MEMSTORE(a3)

mem[a3]=stack [−−tos];

With the above code (and other code that similarly uses an in-memory software managed stack), there is a risk of interlocks. For instance, there is a risk of interlocks when popping operand1 and operand2 from the stack to perform the add operation of the operands, and in popping the top of the stack to store the result in memory. These interlocks are expensive, in terms of performance, since stack [tos] is a memory location, and memory is being accessed often.

Thus, in accordance with an aspect of the present invention, the software managed stack is implemented in a stack accelerator located within a processor. With such an implementation, one or more memory operations used to access memory locations to push or pop an element (or a value in a stack entry) to/from the stack are converted from the in-memory operations to one or more stack accelerator accesses, as described in further detail below.

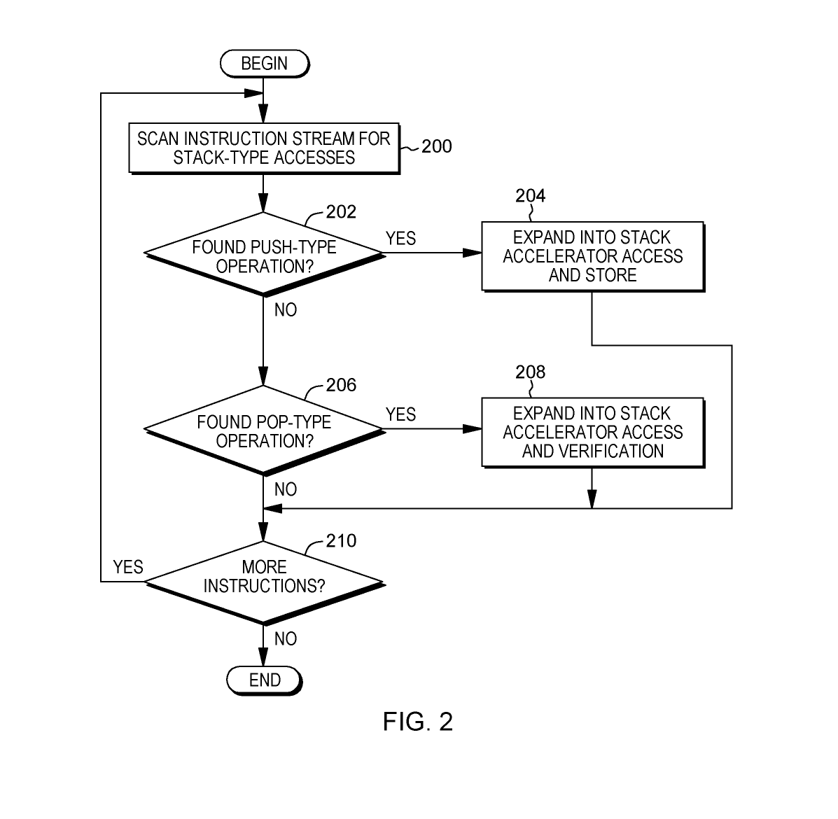

In one example, a technique is provided that recognizes a stack-type access corresponding to a software managed stack and replaces memory operations used to perform the stack-type access with one or more internal operations (e.g., read, write operations) to access the stack in a stack accelerator. One embodiment of this processing is described with reference to FIG. 2. In one example, this processing is performed by a processor, such as an instruction decode unit, logic operatively coupled to the instruction decode unit, a pre-decode logic unit, or another unit of the processor.

Referring to FIG. 2, in one example, an instruction stream is scanned for stack-type accesses, such as an add to the stack (push) or a removal from the stack (pop), or another operation or sequence of operations that represents a push or pop stack operation, STEP 200. As an example, a stack-type access may be recognized by detecting an initial sequence of accesses to establish use of a software managed stack. Such an initial sequence of accesses may be detected based on addresses, instruction patterns or software hints, as examples. For instance, word accesses to, e.g., 100, 104, 108, 112 in direct succession or shortly after each other may indicate an initial sequence of accesses indicating a stack-type access. This sequence may be detected by, for instance, prefetch logic, as examples. As another example, some processors have instructions that update a software managed stack, and detection of one of these instructions indicates a stack-type access. Such instructions include load with update and store with update instructions provided in, e.g., the Power architecture; and post increment and pre-decrement instructions provided in, e.g., PDP11, VAX architectures. In yet another example, software can indicate that a stack is allocated and inform the processor to identify accesses to a region as being based on a stack access. Yet further, a particular register may be used to track a top of stack (tos) pointer and use of this register in the instruction stream may indicate use of a stack. Other techniques may also be used to detect stack-type accesses.

A determination is made as to whether an operation has been found that adds or pushes an element on a software managed stack (referred to as a push-type operation), INQUIRY 202. If a push-type operation is recognized, then the operation to add a value to the stack in memory (e.g., a store operation) is converted to one or more operations (e.g., a write operation) that push the element onto a stack located within the stack accelerator, STEP 204. Optionally, the value may also be stored in memory. In one example, for a push operation, a write to the in-processor stack is performed and a pointer that tracks the top of stack is incremented or decremented, depending on the stack structure (e.g., whether the stack grows upward or downward). In one embodiment, although an address is not needed to push/pop an element from the stack, addresses may be generated for the stack (e.g., an address of the top of stack or the next top of stack) and address verification may be performed to ensure that the generated address associated with placing the element on the stack corresponds to a next address of the stack. Further, in one embodiment, the memory address of the value being stored may also be pushed onto the stack or otherwise maintained by the stack accelerator. Thereafter, in one example, processing continues to INQUIRY 210. In another embodiment, processing ends.

Returning to INQUIRY 202, if a push-type operation is not found, then a determination is made as to whether an operation to remove an element from the stack (referred to as a pop-type operation) is found, INQUIRY 206. If a pop-type operation is found, then the operation to remove a value from the stack in memory is converted to one or more operations (e.g., a read operation) that pop an element from the stack in the stack accelerator, STEP 208. Optionally, verification is performed, STEP 208. For instance, for a pop operation, a memory load from the top of stack is replaced with a read of the stack in the stack accelerator, and the pointer is decremented or incremented, depending on the stack structure. Further, in one example, to perform verification, a received value from the stack is compared with a value obtained from memory at a location corresponding to the popped element (e.g., determined by the store in STEP 204). If the values are equal, verification is successful. Otherwise, an error may be indicated. In a further embodiment, address verification may be performed to determine if the address of the load corresponds to the current top of stack address. For instance, when the value is stored in the stack, the address at which that value is or may have been stored in memory is also saved, and in such embodiment, the addresses may be compared during verification. Other variations are also possible. Thereafter, in one example, processing continues to INQUIRY 210. In another embodiment, processing ends.

Returning to INQUIRY 206, if a stack-type access has not been detected, then a determination is made as to whether there are more instructions to be processed, INQUIRY 210. If so, then processing continues with STEP 200. Otherwise, processing is complete.

In one aspect, computation using a value obtained (via a pop) from the top of stack proceeds without waiting for successful verification, in an embodiment where verification is performed. This allows the processor to proceed with the computation immediately. If verification is subsequently performed and fails, speculative execution using the top of stack value is rolled back, and execution resumes with the correct value.

In another embodiment, verification is not performed because the stack accelerator tracks all updates to the stack accelerator data range, and only correct values are returned without the need for verification.

In a further aspect, memory and the software managed stack located in-processor are kept in synchronization. For example, updates to the stack are written to the local in-processor stack located in the stack accelerator and to memory. Then, when a read is performed to obtain a value off of the stack, verification may be performed comparing the stack value and the in-memory value to determine if they are the same. As a further example, when a write to memory is detected that does not correspond to a stack access, either by the local processor, a remote processor, or another system component (e.g., an I/O device), one or more elements of the stack accelerator may be invalidated. For instance, contents of the corresponding element in the in-processor stack is invalidated, or the entire stack may be invalidated.

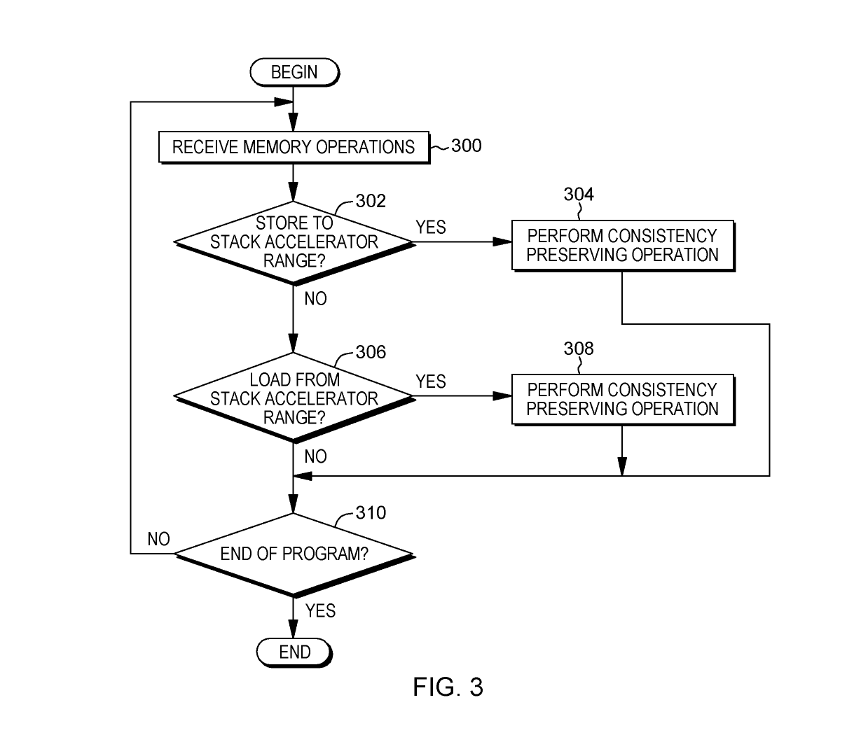

Further details of one embodiment of managing the software managed stack in the stack accelerator are described with reference to FIG. 3. As examples, this processing is performed by the processor (e.g., logic operatively coupled to the stack accelerator) or by logic coupled to the memory subsystem.

Referring to FIG. 3, in one embodiment, a memory operation is received that is requesting access to one or more locations in memory, STEP 300. The requester of the memory may be local or remote. A determination is made as to whether the requested memory operation corresponds to a store to memory, in which the address indicated in the store operation corresponds to an address range within the stack accelerator, INQUIRY 302. If the memory operation is to an address in the stack accelerator, then a consistency preserving operation is performed, STEP 304. This may include, for instance, either updating the memory and the stack, or invalidating one or more entries from the stack in the stack accelerator. Other variations are possible. Processing may then continue to INQUIRY 310 or processing may end.

Returning to INQUIRY 302, if the memory operation is not a store operation that corresponds to an address of the stack accelerator, then a further determination is made as to whether the memory operation is a load operation specifying an address within the address range of the stack accelerator, INQUIRY 306. If the memory operation is such a load operation, then a consistency preserving operation is performed, STEP 308. In this example, this may include providing the requested value from the stack accelerator to the requestor. Other variations are possible. Processing may continue to INQUIRY 310 or processing may end.

Returning to INQUIRY 306, if the requested memory operation does not correspond to a store or a load of a stack in the stack accelerator, then a determination is made as to whether it is the end of a program, INQUIRY 310. If not, then processing continues, STEP 300.

In one aspect, when the content of system memory is synchronized with the stack accelerator, e.g., by performing the optional store of STEP 204, INQUIRY 306 may be omitted, in one embodiment.

In a further aspect, the memory synchronization and/or verification is not performed, since it is architecturally defined that if an address is located in the stack, than the stack will be accessed, instead of memory. Any errors that occur based on not adhering to the architectural definition are to be addressed by the programmer.

In another embodiment, changes to memory and/or the stack are tracked as they occur, and the tracked changes are used to maintain synchronization.

In yet a further embodiment, transactional memory hardware may be used to track changes to memory. Transactional memory has the capability to track interference, to track access to a range of memory locations that correspond to transactional state, and that capability may be used to track whether a stack corresponding to the in-memory locations is being modified. Many variations and embodiments are possible.

As described herein, a software managed stack is implemented in a stack accelerator to provide efficiencies in processing that uses such stacks. For instance, since memory addresses are not used to access the stack, address generation, address translation, and/or interlock/interference testing may be avoided.

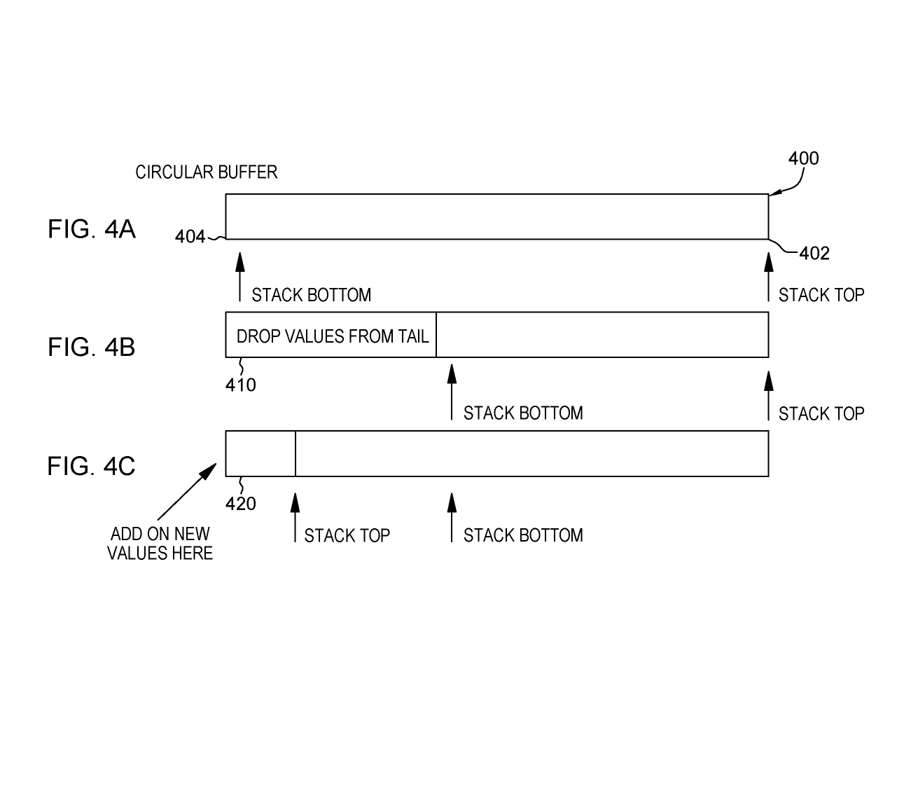

In one example, the stack may be implemented as a circular buffer. In such an embodiment, an overflow condition is managed by removing one or more entries from the end of stack when the stack is full and reusing those entries. This is further described with reference to FIGS. 4A-4C.

In one example, referring to FIG. 4A, a stack 400 is implemented as a circular buffer that has a plurality of elements (or entries). The top of the stack (tos) 402 is indicated by a stack pointer and the bottom of the stack is shown at 404. The buffer is, for instance, a last in first out implementation in which the last values to be placed on the buffer are the first values to be removed. However, when the buffer is full, in one example, entries at the bottom or tail of the stack are removed, as shown in FIG. 4B at 410. By releasing the tail of the stack, values are not lost, in one embodiment, since the values were also written to memory. As an example, when a push onto the stack is performed, the value may be written to memory. In a further example, if the value is not written to memory when the push is performed, then the values may be written to memory at the time of releasing the tail of the stack.

Further, as shown in FIG. 4C, new values may be added on to the top of the stack, as shown at 420.

In a further aspect, during a context switch, the new context is prevented from accessing the stack in the stack accelerator for the previous context. In one embodiment, the stack entries may be invalidated and reloaded for the new context. Further, in one embodiment, address verification may be used to determine if one or more entries of the stack accelerator are to be invalidated. In another embodiment, data value verification in accordance with STEP 208 detects and prevents data corruption as a result of a context switch. Other possibilities also exist.

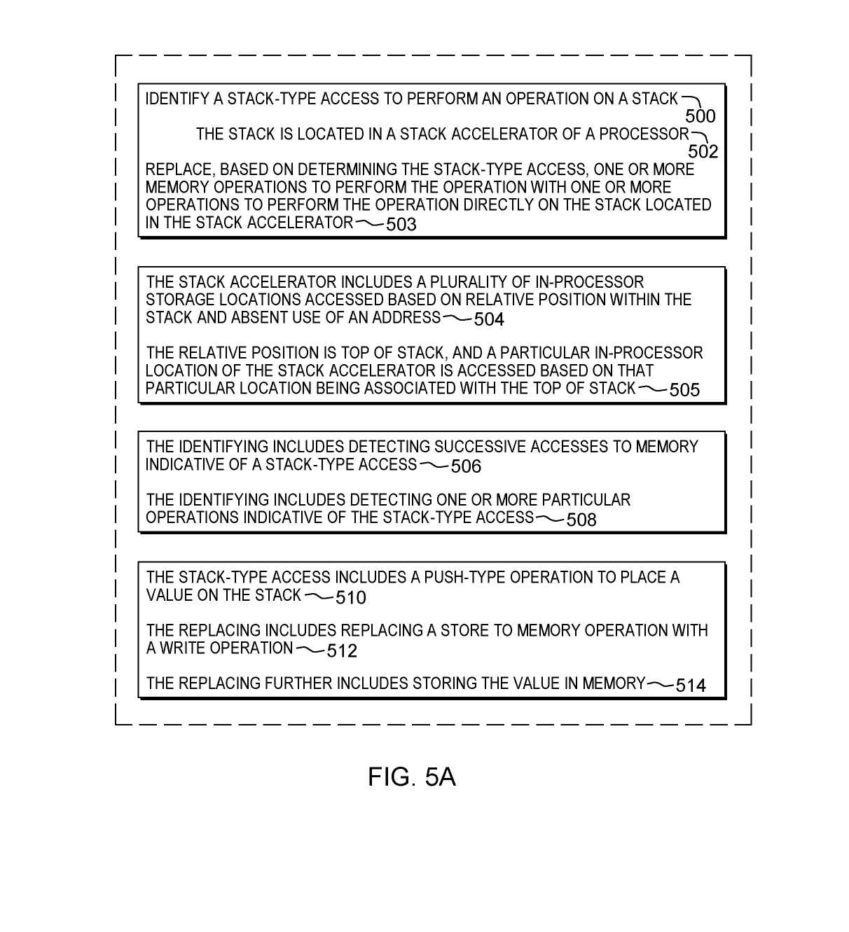

One or more aspects of the present invention are inextricably tied to computer technology and facilitate processing within a computer, improving performance thereof. Further details of one embodiment of facilitating processing within a computing environment, as it relates to one or more aspects of the present invention, are described with reference to FIGS. 5A-5B.

Referring to FIG. 5A, in one embodiment, a stack-type access to perform an operation on a stack is identified (500). The stack is located in a stack accelerator of a processor (502). Based on determining the stack-type access, one or more memory operations to perform the operation are replaced with one or more operations to perform the operation directly on the stack located in the stack accelerator (503).

As an example, the stack accelerator includes a plurality of in-processor storage locations accessed based on relative position within the stack and absent use of an address (504). The relative position is, for instance, top of stack, and a particular in-processor location of the stack accelerator is accessed based on that particular location being associated with the top of stack (505).

In one example, the identifying includes detecting successive accesses to memory indicative of a stack-type access (506). In a further example, the identifying includes detecting one or more particular operations indicative of the stack-type access (508). Other techniques to identify stack-type accesses are also possible.

As a particular example, the stack-type access includes a push-type operation to place a value on the stack (510). The replacing includes, for instance, replacing a store to memory operation with a write operation (512). Further, in one example, the replacing further includes storing the value in memory (514).

In a further aspect, referring to FIG. 5B, a pop-type operation to remove the value from the stack is received (516). Based on receiving the pop-type operation, a read operation is performed to read the value (518). Further, in one example, verification is performed for the read value (520). The performing verification includes comparing the value read from the stack with the value stored in memory (522).

In another particular example, the stack-type access includes a pop-type operation to remove a value from the stack (530). The replacing includes, for instance, replacing a load from memory operation with a read operation (532).

In a further aspect, a memory operation is obtained (534), and based on obtaining the memory operation, a determination is made as to whether the memory operation corresponds to an address associated with the stack accelerator (536). Based on determining the memory operation corresponds to the address associated with the stack accelerator, a consistency preserving operation is performed (538).

As one example, the memory operation includes a store operation (540), and the performing the consistency preserving operation includes performing at least one of updating the stack and updating the memory to provide consistency (542).

As another example, the memory operation includes a load operation (544), and the performing the consistency preserving operation includes providing a requested value from the stack rather than memory (546).

Other variations and embodiments are possible.

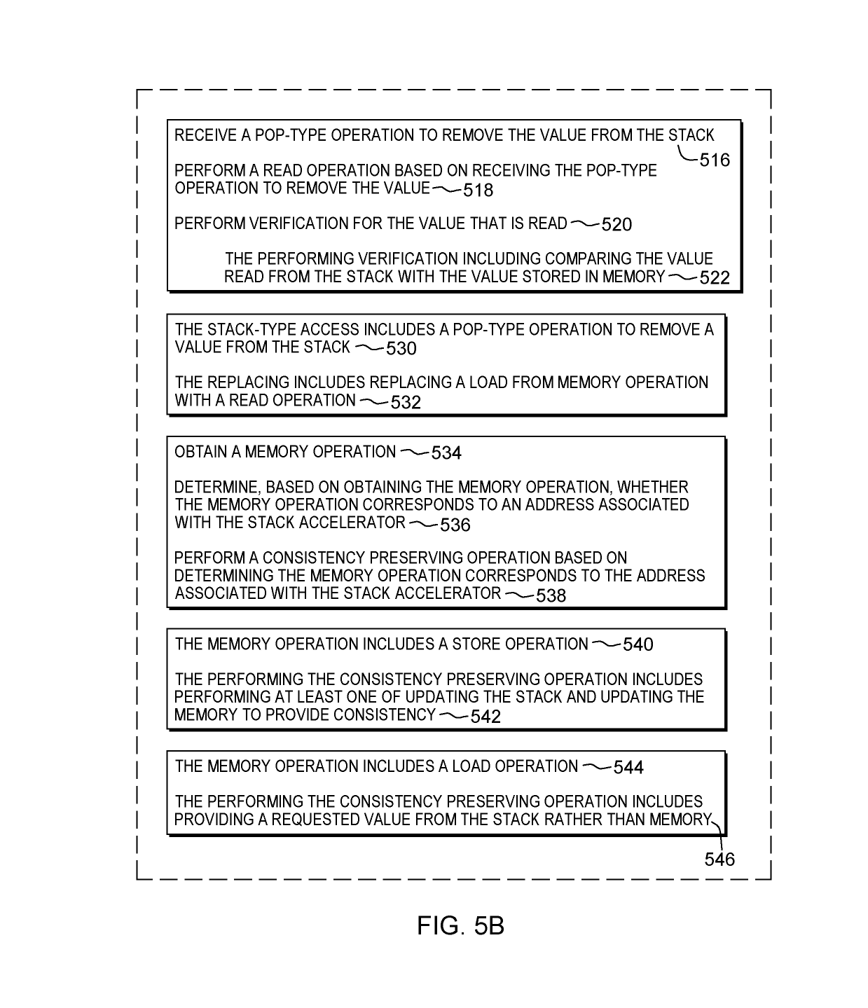

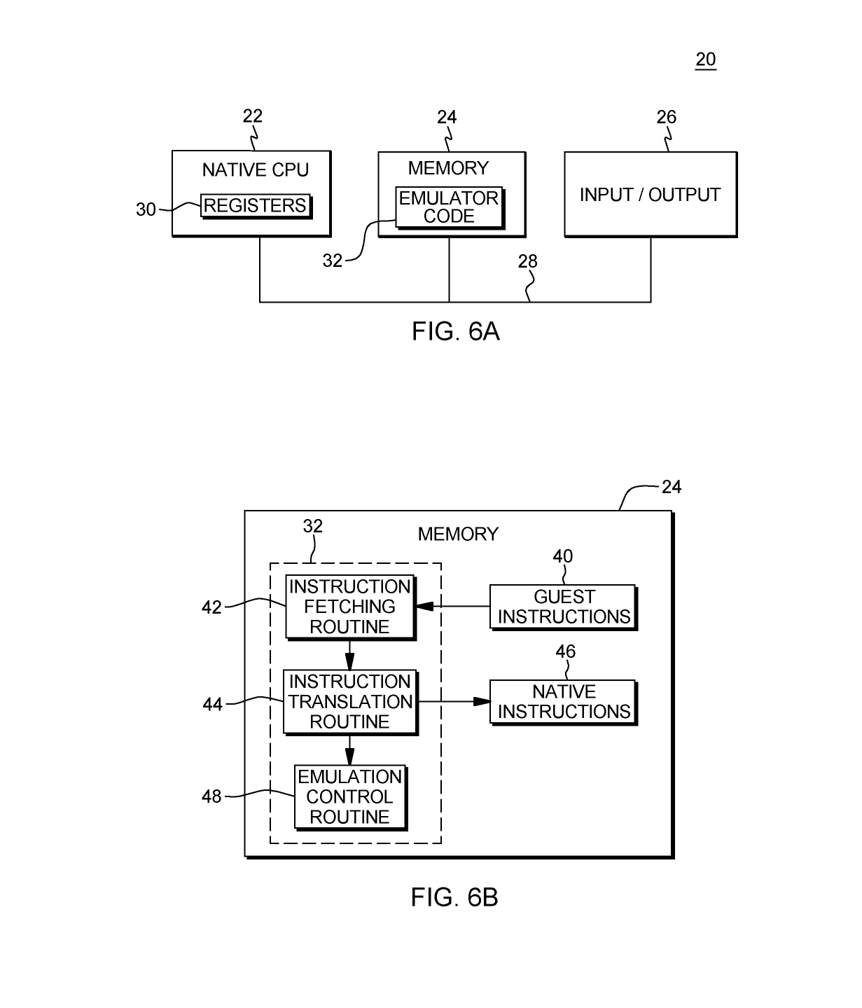

Other types of computing environments may also incorporate and use one or more aspects of the present invention, including, but not limited to, emulation environments, an example of which is described with reference to FIG. 6A. In this example, a computing environment 20 includes, for instance, a native central processing unit (CPU) 22, a memory 24, and one or more input/output devices and/or interfaces 26 coupled to one another via, for example, one or more buses 28 and/or other connections. As examples, computing environment 20 may include a PowerPC processor or a pSeries server offered by International Business Machines Corporation, Armonk, N.Y.; and/or other machines based on architectures offered by International Business Machines Corporation, Intel, or other companies.

Native central processing unit 22 includes one or more native registers 30, such as one or more general purpose registers and/or one or more special purpose registers used during processing within the environment. These registers include information that represents the state of the environment at any particular point in time.

Moreover, native central processing unit 22 executes instructions and code that are stored in memory 24. In one particular example, the central processing unit executes emulator code 32 stored in memory 24. This code enables the computing environment configured in one architecture to emulate another architecture. For instance, emulator code 32 allows machines based on architectures other than the z/Architecture, such as PowerPC processors, pSeries servers, or other servers or processors, to emulate the z/Architecture and to execute software and instructions developed based on the z/Architecture.

Further details relating to emulator code 32 are described with reference to FIG. 6B. Guest instructions 40 stored in memory 24 comprise software instructions (e.g., correlating to machine instructions) that were developed to be executed in an architecture other than that of native CPU 22. For example, guest instructions 40 may have been designed to execute on a z/Architecture processor, but instead, are being emulated on native CPU 22, which may be, for example, an Intel processor. In one example, emulator code 32 includes an instruction fetching routine 42 to obtain one or more guest instructions 40 from memory 24, and to optionally provide local buffering for the instructions obtained. It also includes an instruction translation routine 44 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 32 includes an emulation control routine 48 to cause the native instructions to be executed. Emulation control routine 48 may cause native CPU 22 to execute a routine of native instructions that emulate one or more previously obtained guest instructions and, at the conclusion of such execution, return control to the instruction fetch routine to emulate the obtaining of the next guest instruction or a group of guest instructions. Execution of native instructions 46 may include loading data into a register from memory 24; storing data back to memory from a register; or performing some type of arithmetic or logic operation, as determined by the translation routine.

Each routine is, for instance, implemented in software, which is stored in memory and executed by native central processing unit 22. In other examples, one or more of the routines or operations are implemented in firmware, hardware, software or some combination thereof. The registers of the emulated processor may be emulated using registers 30 of the native CPU or by using locations in memory 24. In embodiments, guest instructions 40, native instructions 46 and emulator code 32 may reside in the same memory or may be disbursed among different memory devices.

As used herein, firmware includes, e.g., the microcode of the processor. It includes, for instance, the hardware-level instructions and/or data structures used in implementation of higher level machine code. In one embodiment, it includes, for instance, proprietary code that is typically delivered as microcode that includes trusted software or microcode specific to the underlying hardware and controls operating system access to the system hardware.

A guest instruction 40 that is obtained, translated and executed may be, for instance, one of the instructions described herein. The instruction, which is of one architecture (e.g., the z/Architecture), is fetched from memory, translated and represented as a sequence of native instructions 46 of another architecture (e.g., PowerPC, pSeries, Intel, etc.). These native instructions are then executed.

One or more aspects may relate to cloud computing.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

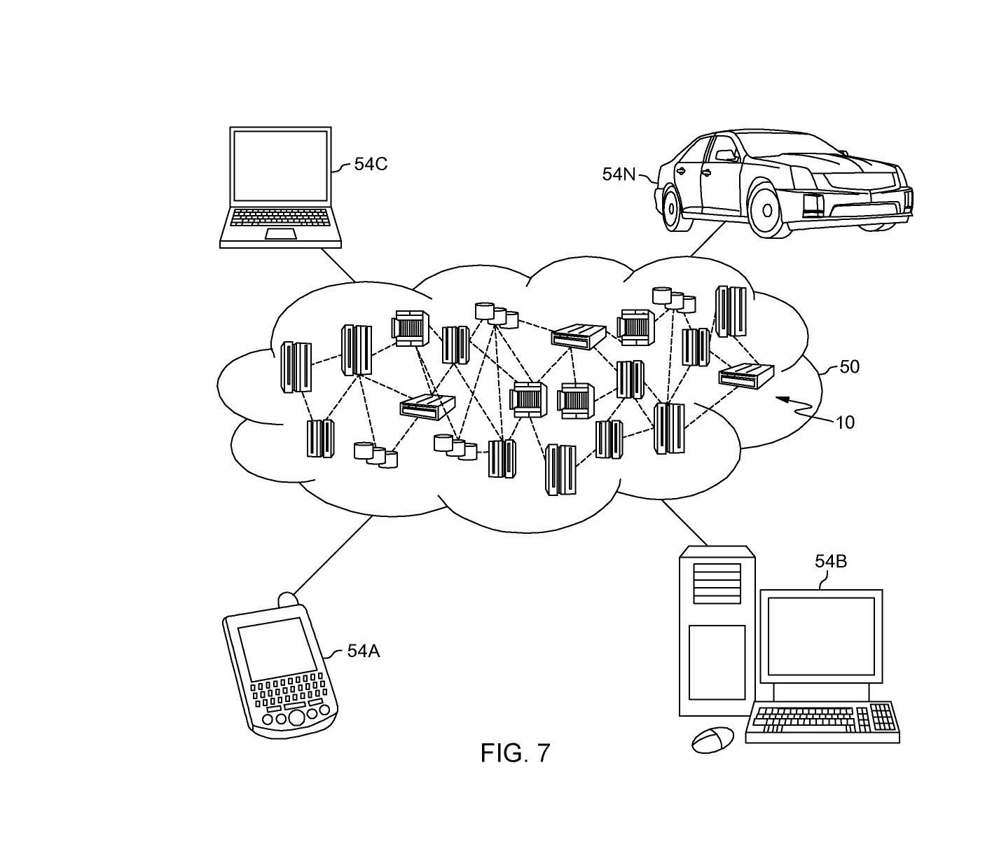

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

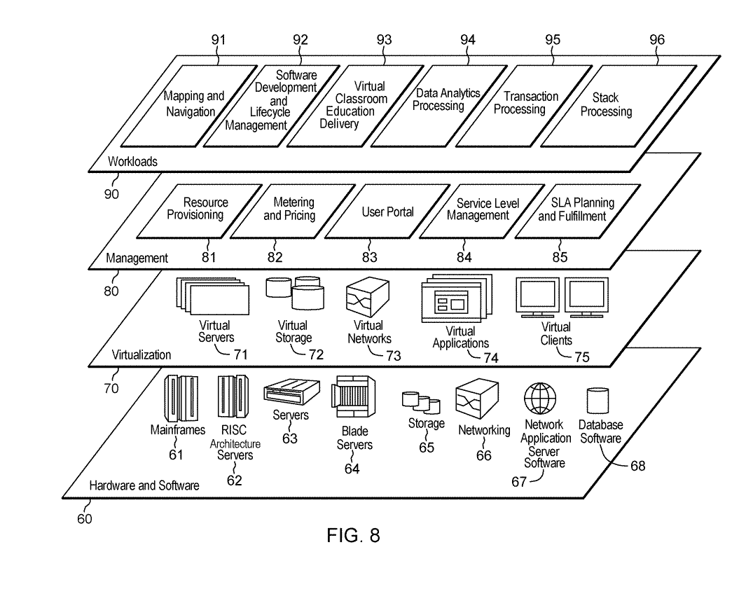

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and in-processor stack processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, computing environments of other architectures can be used to incorporate and use one or more embodiments. Further, different instructions/operations may be used. Moreover, other in-processor stacks and/or stack accelerators may be used. Each in-processor stack may have a stack pointer maintained in a register associated with that stack. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
a computer readable storage medium readable by a processing circuit and storing instructions for performing a method comprising:
identifying a stack-type access to perform an operation on a stack, the stack located in a stack accelerator of a processor; and
replacing, based on determining the stack-type access, one or more memory operations to perform the operation with one or more operations to perform the operation directly on the stack located in the stack accelerator.

2. The computer program product of claim 1, wherein the stack accelerator comprises a plurality of in-processor storage locations accessed based on relative position within the stack and absent use of an address.

3. The computer program product of claim 2, wherein the relative position is top of stack, and wherein a particular in-processor location of the stack accelerator is accessed based on that particular location being associated with the top of stack.

4. The computer program product of claim 1, wherein the identifying comprises detecting one or more particular operations indicative of the stack-type access or detecting successive accesses to memory indicative of the stack-type access.

5. The computer program product of claim 1, wherein the stack-type access comprises a push-type operation to place a value on the stack, and the replacing comprises replacing a store to memory operation with a write operation.

6. The computer program product of claim 5, wherein the replacing further comprises storing the value in memory.

7. The computer program product of claim 6, wherein the method further comprises:
receiving a pop-type operation to remove the value from the stack; and
performing a read operation based on receiving the pop-type operation to remove the value.

8. The computer program product of claim 7, wherein the method further comprises performing verification for the value that is read, the performing verification comprising comparing the value read from the stack with the value stored in memory.

9. The computer program product of claim 1, wherein the stack-type access comprises a pop-type operation to remove a value from the stack, and the replacing comprises replacing a load from memory operation with a read operation.

10. The computer program product of claim 1, wherein the method further comprises:
obtaining a memory operation;
determining, based on obtaining the memory operation, whether the memory operation corresponds to an address associated with the stack accelerator; and
performing a consistency preserving operation based on determining the memory operation corresponds to the address associated with the stack accelerator.

11. The computer program product of claim 10, wherein the memory operation comprises a store operation, and the performing the consistency preserving operation comprises performing at least one of updating the stack and updating the memory to provide consistency.

12. The computer program product of claim 10, wherein the memory operation comprises a load operation, and the performing the consistency preserving operation comprises providing a requested value from the stack rather than memory.

13. A computer system for facilitating processing within a computing environment, the computer system comprising:
a memory; and
a processor in communication with the memory, wherein the computer system is configured to perform a method, said method comprising:
identifying a stack-type access to perform an operation on a stack, the stack located in a stack accelerator of a processor; and
replacing, based on determining the stack-type access, one or more memory operations to perform the operation with one or more operations to perform the operation directly on the stack located in the stack accelerator.

14. The computer system of claim 13, wherein the stack accelerator comprises a plurality of in-processor storage locations accessed based on relative position within the stack and absent use of an address.

15. The computer system of claim 13, wherein the stack-type access comprises a push-type operation to place a value on the stack, and the replacing comprises replacing a store to memory operation with a write operation.

16. The computer system of claim 13, wherein the stack-type access comprises a pop-type operation to remove a value from the stack, and the replacing comprises replacing a load from memory operation with a read operation.

17. A computer-implemented method of facilitating processing within a computing environment, the computer-implemented method comprising:
identifying a stack-type access to perform an operation on a stack, the stack located in a stack accelerator of a processor; and
replacing, based on determining the stack-type access, one or more memory operations to perform the operation with one or more operations to perform the operation directly on the stack located in the stack accelerator.

18. The computer-implemented method of claim 17, wherein the stack accelerator comprises a plurality of in-processor storage locations accessed based on relative position within the stack and absent use of an address.

19. The computer-implemented method of claim 17, wherein the stack-type access comprises a push-type operation to place a value on the stack, and the replacing comprises replacing a store to memory operation with a write operation.

20. The computer-implemented method of claim 17, wherein the stack-type access comprises a pop-type operation to remove a value from the stack, and the replacing comprises replacing a load from memory operation with a read operation.
